(19) United States
(12) Patent Application Publication
(10) Pub. No.: US 2025/0262892 A1
(43) Pub. Date: Aug. 21, 2025

(54) AXLE SUPPORT SYSTEM FOR A VEHICLE AXLE

(71) Applicant: ZF Friedrichshafen AG, Friedrichshafen (DE)

(72) Inventors: Karlheinz Hoher, Markdorf (DE); Andreas Acker, Meckenbeuren (DE); Julian Lüftl, Tiefenbach (DE)

(73) Assignee: ZF Friedrichshafen AG, Friedrichshafen (DE)

(21) Appl. No.: 19/050,651

(22) Filed: Feb. 11, 2025

(30) Foreign Application Priority Data
Feb. 15, 2024 (DE) 10 2024 201 372.2

(51) Int. Cl. B60B 27/02; B60B 27/00; F16C 33/66

(52) U.S. Cl. CPC B60B 27/02; B60B 27/0073; F16C 33/6681; B60B 2900/511; B60B 2900/561

(57) ABSTRACT

An axle bridge system has an axle shaft and an axle bridge with a tubular section defining an inside space. The axle shaft is mounted rotatably and extends axially through the inside space, which can be filled at least partially by a lubricating fluid to define a first lubricating fluid space and a first lubricating fluid reservoir. A bearing in the wheel head rotatably supports the axle shaft, an end of which has a flange in contact with the wheel head to define a hollow space. The wheel head defines a second lubricating fluid space forming a second lubricating fluid reservoir, the second lubricating fluid space connected to the bearing for lubricating the bearing. A sealing ring between the axle bridge and the axle shaft blocks the connection between the bearing and the inside space to seal the first lubricating fluid reservoir relative to the second lubricating fluid reservoir.

### RELATED APPLICATIONS

This application claims the benefit of and right of priority under 35 U.S.C. § 119 to German Patent Application no. 10 2024 201 372.2, filed on 15 Feb. 2024, the contents of which are incorporated herein by reference in its entirety.

### FIELD OF THE DISCLOSURE

The invention relates to an axle bridge system for a vehicle axle, the axle bridge system comprising an axle shaft and an axle bridge with a tubular section whereby an inside space is formed, wherein through the inside space the axle shaft is fitted and extends rotatably in an axial direction, wherein the inside space can be at least partially filled with a lubricating fluid to form a first lubricating fluid space and a first lubricating fluid reservoir, wherein further a wheel head with a bearing is provided, wherein the bearing is arranged in the wheel head and supports the axle shaft rotatably, and wherein at its end the axle shaft forms an end-flange which is arranged on the wheel head and forms a hollow space with the wheel head. so that a connection is formed between the bearing and the inside space.

### BACKGROUND

Driven axles of vehicles usually take the form of an axle bridge connected to a vehicle chassis, at the ends of which in each case a wheel bead is provided in order to receive a vehicle wheel to be driven. Such wheel heads comprise in particular bearings for the support of a flanged shaft or a stub shaft (axle shaft) which is arranged in the axle bridge.

WO 2018224231 A1 discloses a wheel bead for the driven steered wheels of utility vehicles with a wheel head carrier in the form of a swivel part that comprises a fork and a trunnion, wherein the trunnion projects into the inside space of a wheel hub through a seal and the wheel bub is mounted on the trunnion and can rotate about a rotation axis, with reduction gearing within the inside space by means of which, via a driveshaft that extends through a seal into the wheel bub, the wheel hub can be driven in rotation, wherein at least one component of the reduction gearing is fully or partially immersed in an oil sump in the inside space of the wheel hub, wherein a venting duct is formed in the wheel head carrier which opens at its first end above the level of the oil sump in the inside space of the wheel hub and whose second end is higher than the first end and opens into the surroundings. wherein at one point between the first end and before the second end of the venting duct there is a space with a larger radial size than the part of the venting duct between the space of larger radial size and the second end of the venting duct.

DE 10 2022 212022 A1 discloses a seal arrangement for a wheel bearing arrangement with an inner axle and a rotatable outer hub which is arranged around the axle. The seal arrangement comprises an annular inner housing with an axial section that can be arranged around the axle, and a radial section that extends outward from the axial section.

### SUMMARY

The bearings of the wheel head can be lubricated above all with oil as the lubricating fluid, which comes from the axle bridge, or lubricated with grease.

The purpose of the present invention is to provide an improved axle bridge system with a wheel head.

This objective is achieved by an axle bridge system with the features disclosed herein.

The objective is achieved by an axle bridge system for a vehicle axle, the axle bridge system comprising:
an axle shaft and an axle bridge which comprises a tubular section by which an inside space is formed, through which the axle shaft is mounted to rotate and extends in an axial direction, wherein the inside space can be at least partially filled with lubricating fluid to form a first lubricating fluid space and a first lubricating fluid reservoir, wherein further, a wheel head with a bearing is provided, such that the bearing is arranged in the wheel head and supports the axle shaft rotatably, and
wherein at its end the axle shaft forms an end-flange which is arranged on the wheel head and which, with the wheel head, forms a hollow space so that there is a connection between the bearing and the inside space,
wherein a second lubricating fluid space is provided in order to form a second lubricating fluid reservoir, such that the second lubricating fluid space is arranged in the wheel head and is connected fluidically with the bearing in order to lubricate the bearing with lubricating fluid,
and wherein a sealing ring is provided, which is arranged between the axle bridge and the axle shaft in order to separate the connection between the bearing and the inside space, so sealing the first lubricating fluid reservoir from the second lubricating fluid reservoir.

In this case, the sealing ring is arranged between the axle bridge and the axle shaft either directly in contact with them or, for example, indirectly by way of an intermediate element.

The use of various outsourced components in the area of the drive axle is a particular challenge, particularly if the outsourced components are to be used for example in a variety of drive axles.

According to the invention, it was recognized that in a module-like structure of a vehicle axle or drive axle, for example by outsourcing a wheel head, in the bearing of the wheel head no machine oil used to lubricate the E-machine should be used since that would bring about a substantial useful-lifetime reduction.

Accordingly, when a variety of wheel heads are used separate lubrication of the wheel heads is required; for example, the wheel heads should be lubricated with a conventional axle oil.

Thanks to the axle bridge system according to the invention, a variety of wheel heads can be used.

For that purpose, the axle bridge system comprises an axle shaft or a flange shaft or a stub shaft. In addition, the axle bridge system comprises an axle bridge, also known as an axle housing, which has a tubular section. In the tubular section the axle shaft extends axially and is mounted rotatably, i.e., it is mounted radially a distance away from the section, whereby an inside space is formed. Furthermore, in the inside space a first lubricating fluid, for example, a first oil which is also used for lubricating the E-machine or central unit and which forms a fluid path with the E-machine or central unit, can be present. In that way, a first lubricating fluid reservoir, in this case an oil reservoir (oil sump), is formed. Moreover, a wheel head is present, which has a bearing, for example a roller bearing, which supports the axle shaft rotatably, and which also has to be lubricated.

At its end the axle shaft has an end-flange which is in contact with the wheel head, and which forms a hollow space with the wheel head. The hollow space is connected to the bearing and also to the inside space.

It has been recognized that by the end-flange a fluid path is formed, by which the bearing of the wheel head is connected to the lubricating fluid reservoir.

In addition, according to the invention, there is a second lubricating fluid space, i.e., a second oil space. This is formed in the wheel head and for lubrication purposes is connected to the bearing. The second lubricating fluid space can be a hollow space which is already present, or which is formed in the wheel head for the purpose.

To separate the two lubricating fluid spaces, a sealing ring is provided between the axle shaft and the axle bridge. In this case it is possible for the sealing ring to contact the axle shaft and the axle bridge directly, or indirectly for example, by way of an intermediate element or contact element. In that way, the fluidic connection between the inside space and the bearing is interrupted, i.e., the inside space and the bearing are now fluidically separated. Thus, the two oil reservoirs are separated.

In that way, in the second lubricating fluid space, which is connected to the bearing of the wheel head, a suitable lubricating fluid such as a suitable axle oil can be used.

Likewise, in the first lubricating fluid space, for example, the oil from the axle body, which is used to lubricate the differential or E-drive, can be present. In this case, the first lubricating fluid space can be filled partially or completely with oil.

By means of the sealing ring according to the invention, the oil spaces can be sealed relative to one another. This prevents mixing of the two different oils. A reduction of the useful lifetime of the wheel head is thereby avoided.

Thus, any wheel head desired can be fitted onto the vehicle axle. Accordingly, the modular structure is made possible. Thanks to the axle bridge system according to the invention, existing wheel heads can be used without modifications. Since such wheel heads are manufactured in large production runs, which bas a positive effect on product price. Likewise, the various wheel heads can work together with a variety of axle bridges.

By virtue of the integration of the additional sealing ring in combination with the second lubricating fluid space, it becomes possible to create separate oil spaces between the wheel heads and the axle bridge or central unit. This also makes it possible to use another oil, such as conventional axle oil, in the wheel bead within the inside space (the first lubricating fluid space).

In this case, the sealing ring between the axle bridge and the axle shaft. for example the flange shaft. can be in the form of a radial shaft seal in order to separate the two lubricating fluid reservoirs, specifically the two oil reservoirs.

As a further development, the sealing ring for separating the first lubricating fluid reservoir and the second lubricating fluid reservoir between the axle bridge and the axle shaft is arranged directly or indirectly, and thus seals the first and second lubricating fluid spaces relative to one another.

As a further development, the sealing ring extends radially between the axle bridge and the axle shaft. In particular, the sealing ring, for example the radial shaft sealing ring, is compressed or stressed between the axle bridge and the axle shaft. This enables simple assembly. In particular the sealing ring has a sealing lip which is pressed against the axle bridge or securely in contact with the axle bridge. Likewise, the sealing ring can comprise a tension spring. The sealing lip can consist of or contain an elastomer. Besides the elastomer, radial shaft sealing rings can comprise the sealing lip, a stiffening ring and a tension spring. The compression of the sealing lip is achieved by prestressing and supported by the tension spring.

As a further development, the sealing ring has two sealing lips which are arranged a distance apart in the axial direction and parallel to one another. In that way one of the sealing lips, in particular the one facing toward the second lubricating fluid space, can prevent any escape of oil or lubricating fluid from the wheel head, i.e., out of the second lubricating fluid space into the first lubricating fluid space, and the sealing lip parallel to it and a distance away can prevent any escape of oil or lubricating fluid from the inside space, i.e., the first lubricating fluid space into the second lubricating fluid space. In this case, to form a sealing ring with two sealing lips the sealing ring, in particular the radial shaft sealing ring, can be divided or comprise at its end two webs or arms of equal length at the ends of which a sealing lip is arranged in each case.

In a further development, the sealing ring is clamped between the axle bridge and the axle shaft, so that the two sealing lips are firmly in contact with the axle bridge and the axle shaft. This enables simple assembly for the sealing of the oil spaces or lubricating fluid spaces relative to one another

In a further development, the sealing ring has at least one sealing lip, whereas the axle bridge bas a sleeve, and the sealing lip is in contact with the axle bridge in the area of the sleeve. In that way, an appropriate surface with a sufficient surface area of the working surface. i.e., the working surface area for the sealing lip can be provided, which is not affected by any wear. The contact area with the axle bridge can accordingly be a direct contact or contact in the form of a pressed-on sleeve or liner

In a further development, the end-flange has an axially projecting sealing ring seat that faces toward the axle bridge, and the sealing ring is arranged between the axle bridge and the sealing ring seat. A sealing ring seat, for example, can be in the form of an all-round tab or projection which projects into the hollow space formed by the end-flange and the axle bridge or wheel head. Such a sealing ring seat can be made integrally with the axle shaft, for example by casting. In particular, for reasons having to do with rotation, this is arranged centrally in the end-flange.

In a further development, a contact element is provided, such that a first portion of the contact element is arranged between the axle bridge and the axle shaft, while a second portion of the contact element projects into the hollow space formed by the end-flange and the wheel head, and wherein the sealing ring is arranged between the second portion of the contact element and the axle shaft. In that way an arrangement on the axle bridge can be dispensed with and there is also no need for a sleeve to be arranged on the axle bridge

In particular, the contact element is S-shaped with respective sections that are straight. Thus, the second portion, which is the upper portion of the S structure, can have a radial projection which improves the stiffness of the contact element.

In a further development the first portion, in particular the straight lower area of the S-shaped contact element, is tensioned between the axle bridge and the axle shaft. By virtue of such tensioning, the fitting of the contact element is simplified.

In a further development, the sealing ring has respective oppositely directed sealing lips. In that way the two different lubricating fluids, in this case oils, can be kept apart particularly effectively.

In particular, the sealing ring is in the form of a radial shaft sealing ring. This is particularly well suited for the sealing of lubricating oils, since the sealing lip of the radial shaft sealing ring floats on the lubricating film formed by the medium to be sealed. That prevents premature wear and thermal destruction of the sealing lip.

In a further development, venting ducts for venting are formed in the wheel head and the axle bridge, the venting ducts being connected with the second lubricating fluid space, so enabling it to be vented to the outside. The second oil space or oil sump is thus vented and can thereby compensate temperature fluctuations. The venting ducts can be in the form of a plurality of interconnected longitudinal and transverse bores made in the wheel head and the axle bridge. By means of such a structure the wheel head or the second lubricating fluid space can be vented directly to the surroundings.

Alternatively venting ducts for venting are formed in the wheel head and the axle bridge, wherein the venting ducts are connected to the second lubricating fluid space via an adjacent main aggregate. In that way, common venting can take place. The venting ducts can be in the form of a plurality of interconnected longitudinal and transverse bores made in the wheel head and the axle bridge. In that way, a direct venting of the second lubricating fluid space is not necessary. The air flows outward by way of the main aggregate, for example a transmission, with the transmission air via an aggregate venting system.

### BRIEF DESCRIPTION OF THE DRAWINGS

Further properties and advantages of the present invention emerge from the following description, which refers to the attached drawings showing:

FIG. 1: An axle bridge system according to the prior art.

FIG. 2: A first design of an axle bridge system according to the invention.

FIG. 3: A second design of an axle bridge system according to the invention.

FIG. 4: A third design of an axle bridge system according to the invention.

FIG. 5: A sealing ring.

FIG. 6: An axle bridge system with venting ducts.

FIG. 7: A further axle bridge system with venting ducts.

FIG. 8: A further axle bridge system with venting ducts.

### DETAILED DESCRIPTION

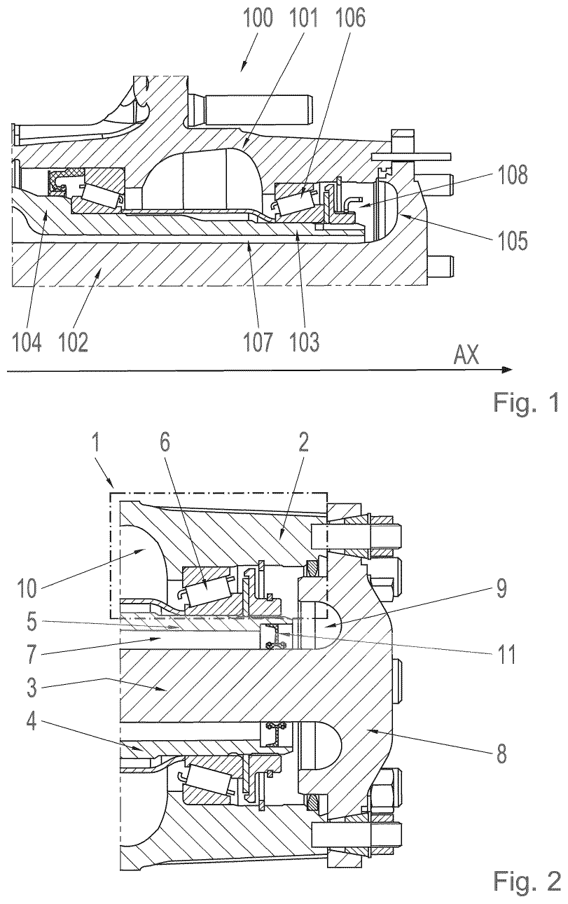

FIG. 1 shows and axle bridge system 100 according to the prior art for a vehicle axle.

In this case the axle bridge system 100 comprises a wheel head 101.

Furthermore, there is an axle shaft 102 and an axle bridge 104 (axle housing), which has a tubular section 103 through the inside space of which the axle shaft 102 is mounted rotatably and extends in an axial direction AX. Thus, the axle shaft 102 extends axially in the inside space and is mounted rotatably, i.e., a radial distance away from the axle bridge 104. Thus, in the inside space a first oil, which is also used to lubricate the E-machine or central unit, can be present. In that way, an oil reservoir (lubricating fluid space) in the form of an oil sump 107 is formed.

In addition, the wheel head 101 has a bearing 106, the bearing 106 supporting the axle shaft 102. The bearing 106 can in particular be a roller bearing that has to be lubricated.

Moreover, at one end the axle shaft 102 has an end-flange 105. which forms a hollow space 108 with the wheel head 101 so that there is a fluidic connection between the bearing 106 and the inside space via the hollow space. Thanks to the connection oil can get from the oil sump 107 to the bearing in order to lubricate it.

According to the invention, it was recognized that when using different wheel heads 101, for example outsourced wheel heads 101, often the bearing 106 should not be lubricated with machine oil from the oil sump 107, i.e., no machine oil should be used to lubricate the E-machine since doing so results in a substantial reduction in the useful-lifetime. According to the invention it was recognized that when using a variety of wheel heads 101, separate lubrication of the wheel heads 101 is necessary, for example the wheel heads 101 should be lubricated with a conventional axle oil.

FIG. 2 shows a first design of an axle bridge system 1 according to the invention.

The axle bridge system 1 comprises a wheel head 2.

Furthermore, there is an axle shaft 3 as well as an axle bridge (axle housing) 4, which has a tubular section 5 through the inside space of which the axle shaft 3, which is mounted rotatably, extends in an axial direction AX. Thus, the axle shaft 3 extends axially in the inside space and is mounted rotatably, i.e., it is fitted a radial distance away from the axle bridge 4. In that way, in the inside space a first oil, which is also used to lubricate the E-machine or central unit, can be present. This forms a first oil reservoir or oil sump (lubricating fluid space) 7.

In addition, the wheel bead 2 has a bearing 6 which supports the axle shaft 3 rotatably. The bearing 6 can in particular be a roller bearing that has to be lubricated.

Moreover, a second oil sump 10 is provided as a second oil reservoir, wherein the second oil sump 10 is arranged in the wheel head 2 and is fluidically connected to the bearing 6 in order to lubricate the bearing 6 with oil. The second oil sump 10 can be a hollow space which is already present, or which is formed in the wheel head 2 for that purpose.

This means that the second oil sump 10 is arranged in the wheel head 2 and is connected to the bearing 6 in order to oil the bearing 6.

Furthermore, the axle shaft 3 has at its end an end-flange 8, which is in contact with the wheel head 2 and forms with the wheel head 2 a hollow space 9, so that there is a fluidic connection between the bearing 6 and the hollow space 9. Moreover, a sealing ring is present, for example a radial shaft sealing ring 11, which is fitted between the axle shaft 3 and the axle bridge 4. This blocks any fluidic connection between the inside space and the bearing 6, i.e., between the first oil sump 7 and the second oil sump 10.

In that way a separation is created between the first oil sump and the second oil sump. Consequently, for example an axle oil can be used to lubricate the bearing 6.

Thus, between the axle bridge 4 and the axle shaft 3 a radial shaft sealing ring 11 is integrated, to separate the two oil reservoirs. By means of such an integrated radial shaft sealing ring 11 the two oil reservoirs or oil sumps are sealed relative to one another. This prevents any mixing of the different oils. In that way, a reduction in the useful-lifetime of the wheel head 2 is avoided.

In this way, for example a conventional oil can be used in the wheel head 2 for lubricating the bearing 6. whereas in the central unit (E-machine) a conventional E-machine oil can be used.

Likewise, any desired wheel head 2 can be fitted onto the vehicle axle. This makes possible a modular structure. Existing wheel heads 2 can be used without modifications by virtue of the axle bridge system 1 according to the invention. Thereby, for example it is possible to accept completely any existing wheel head 2 comprising, for example, a wheel hub, wheel bearings and associated components such as bolts, nuts etc.

Since such wheel heads are mass-produced in large numbers, this bas a positive effect on the product price. Likewise, the various wheel heads 2 can work together with various manufactured axle bridges.

The radial shaft sealing ring 11 can have a sealing lip 12. Such a sealing lip 12 makes for particularly effective separation of the oil reservoirs.

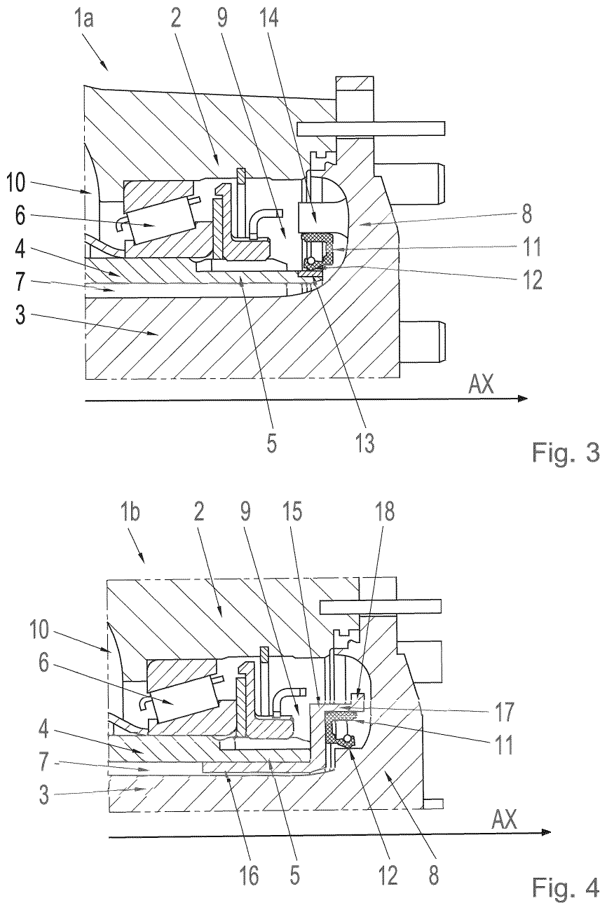

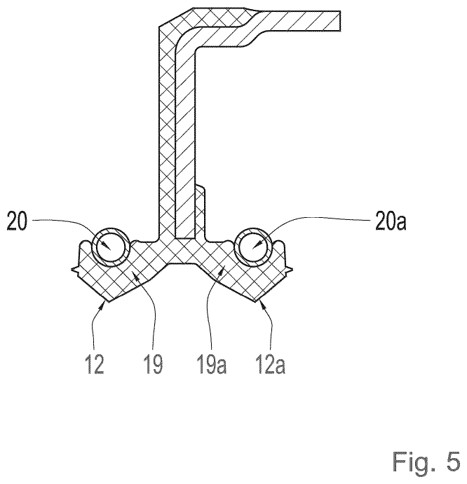

FIG. 3 shows a further design of an axle bridge system 1a according to the invention.

In this case the axle bridge system 1a comprises the wheel head 2 with its bearing 6, the axle shaft 3 and the axle bridge 4 (axle housing) with its tubular section 5. Moreover, the first oil reservoir is formed as the first oil sump (lubricating fluid space) 7. Furthermore, the second oil sump 10 is produced as a second oil reservoir.

In addition, a sleeve 13 is arranged, attached, or pressed onto the axle bridge 4.

In this case the sealing lip 12 contacts the axle bridge 4 in the area of the sleeve 13. Thereby, an appropriate surface with sufficient surface area of the working surface, i.e., the working surface area for the sealing lip 12 can be produced, which is not affected by wear. The pressing-on surface of the axle bridge 4 can in that way be formed by the pressed-on sleeve 13.

Thus, during operation the sealing lip 12 extends over the sleeve 13.

Furthermore, the end-flange 8 has a sealing ring seat 14 facing toward the axle bridge 4 and projecting axially. The radial shaft sealing ring 11 is then arranged between the axle bridge 4, i.e., the sleeve 13 and the sealing ring seat 14. The sealing ring seat 14 can in this case, for example, be in the form of an all-round tab or projection that extends into the hollow space 9 formed by the end-flange 8 and the wheel head 2. Such a sealing ring seat 14 can be made integrally with the axle shaft 3, for example by casting. In particular, for reasons to do with rotation this is arranged centrally in the end-flange 8.

Furthermore, the sealing lip 12 can be in contact with the sleeve 13 or, however, with the sealing ring seat 14. This means that the radial shaft sealing ring can seal toward the inside or toward the outside. It is also possible to provide two such sealing lips 12 opposite one another. In that way the two oil reservoirs can be separate particularly effectively.

FIG. 4 shows a further design of an axle bridge system according to the invention.

In this case, the axle bridge system 1b comprises the wheel head 2 with its bearing 6. the axle shaft 3 and the axle bridge (axle housing) 4 with its tubular section 5. In addition, the first oil reservoir is in the form of a first oil sump (lubricating fluid space) 7.

Moreover, a second oil sump 10 in the form of a second oil reservoir is provided.

In this case, a contact element 15 is provided. The contact element 15 is essentially S-shaped with respective straight portions. The S-shaped contact element 15 has an upper second portion 17 and a lower first portion 16. The lower first portion 16 of the S-shaped contact element 15 can be pressed or clamped between the axle bridge 4 and the axle shaft 3. This enables simple assembly.

The second, upper portion 17 of the S-shaped contact element 15 projects into the hollow space 9 formed by the end-flange 8 and the wheel head 2 and the axle bridge 4. The radial shaft sealing ring 11 is clamped between the second portion 17 of the contact element 15 and the axle shaft 3. In particular, the sealing lip 12 can be in contact with the axle shaft 3. In that way there is no need to arrange the radial shaft sealing ring 11 directly on the axle bridge 4 and thus also on s sleeve 13 arranged on the axle bridge 4. Furthermore, the contact element 15 can have a radial projection 18 to improve the stiffness of the contact element 15.

Thereby, an indirect clamping of the radial shaft sealing ring 11 between the axle bridge 4 and the axle shaft 3 with the contact element 15 as an intermediate element is produced.

Fig. S shows a further design of a radial shaft sealing ring 11a. This has two sealing lips 12, 12a extending in the axial direction parallel to and a distance away from one another.

In that way one of the sealing lips, in particular the sealing lip 12 that faces toward the second oil sump 10, can prevent the escape of oil from the wheel head 2, i.e., from the second oil sump 10 into the first oil sump 7 and the sealing lip 12a parallel to and a distance away from it can prevent the escape of oil or lubricating fluid from the inside space, i.e., from the first oil sump 7 into the second oil sump 10. In this case, to form the two sealing lips 12, 12a the radial shaft sealing ring 11a can be divided at its end into two arms 19, 19a of equal length at the respective ends of which one of the two sealing lips 12, 12a is arranged in each case. Likewise, there can be two tension springs 20, 20a to increase the pressure force.

The sealing lips 12. 12a can be of identical design.

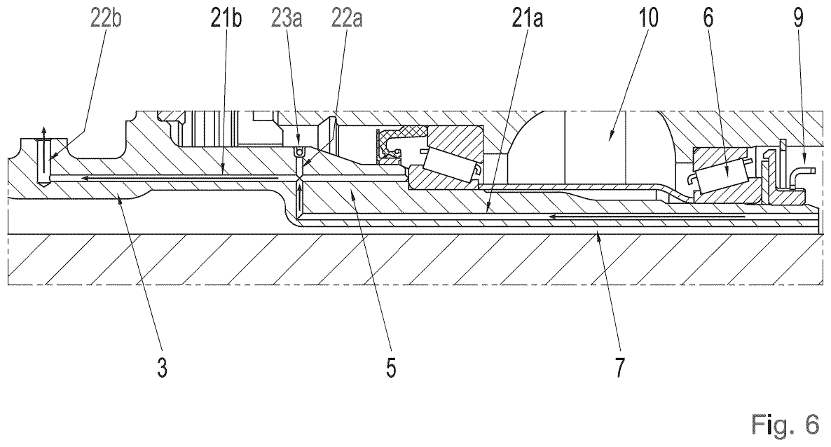

FIG. 6 shows existing venting ducts for venting, which are formed in the wheel head 2 and in the axle bridge 4, the venting ducts being connected to the second oil sump 10 in order to vent the second oil sump 10. In that way the second oil sump 10 is vented and can therefore compensate temperature fluctuations. In the wheel head 2 and the axle bridge 4 the venting ducts can be in the form of a plurality of interconnected longitudinal bores or longitudinal ducts 21a, 21b and transverse bores or transverse ducts 22a, 22b. Several venting paths are then possible. Thus, FIG. 6 illustrates venting in which air flows through the longitudinal duct 21a, then into a transverse duct 22a and then into a longitudinal duct 21b, and finally through a further transverse duct 22b to the outside. The transverse duct 22a is closed by means of a closure plug 23a. Furthermore, the further longitudinal duct 216 is additionally connected to the second oil sump 10; in that way, besides the venting via the longitudinal duct 21a venting also takes place via the longitudinal duct 21b.

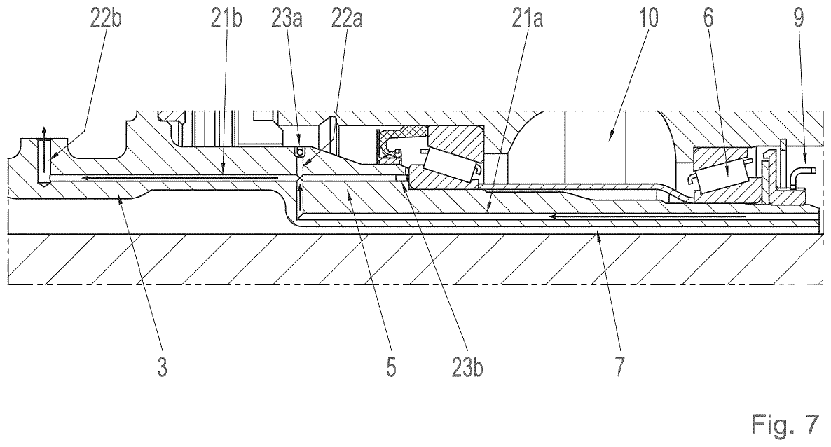

FIG. 7 shows a further venting possibility. In this case the venting of the second oil sump 10 takes place only via the longitudinal duct 21a. The air flow passes through the longitudinal duct 21a, the two transverse ducts 22a, 22b and the further longitudinal duct 21b. The longitudinal duct 21b is closed off by a closure plug 23b in the direction of the second oil sump 10. In addition, the transverse duct 22a is closed by a closure plug 23a. Thus, the venting takes place via the longitudinal duct 21a which leads the air to the outside.

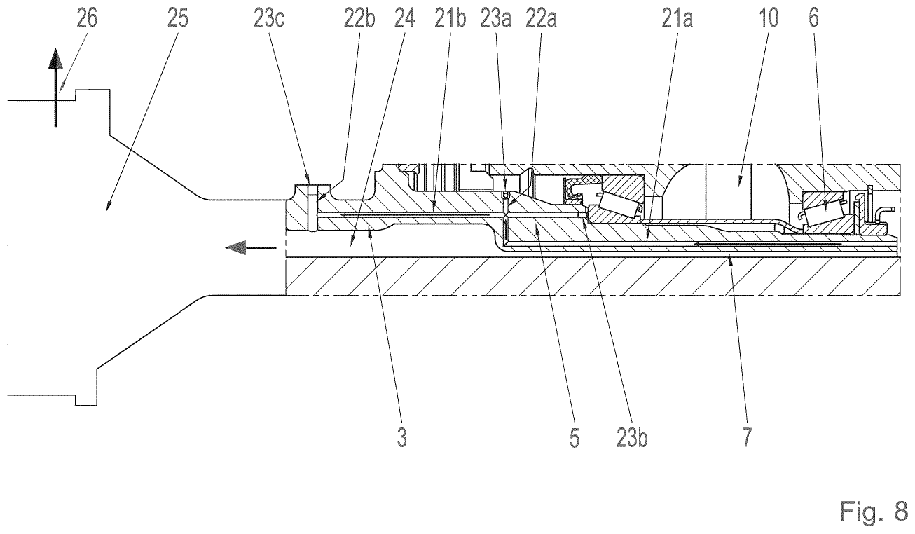

FIG. 8 shows a further possibility for the invention.

In this case, the second oil sump 10 is vented only via the longitudinal duct 21a. Then the air flow passes through the two transverse ducts 22a, 22b and the further longitudinal duct 21b. The longitudinal duct 21b is closed by a closure plug 23b in the direction of the second oil sump 10. In addition, the transverse duct 22a is closed by the closure plug 23a.

Furthermore, the transverse duct 22b is present. However, this extends into an air space 24 between the axle shaft 3 and the axle bridge 4 and is closed off toward the outside by a closure plug 23c. Thus, the second oil sump 10 is vented via the longitudinal duct 21a and the air then flows through the transverse duct 22a into the longitudinal duct 21b and from there, by way of the through-going bore, into the air space 24. Then the air flows via the main aggregate 25, for example the transmission with the transmission air, via an aggregate vent 26 to the outside. In that way there is no need for direct venting of the second oil sump 10 and hence a direct connection to corresponding venting ducts to the exterior environment.

### LIST OF INDEXES

100 Axle bridge system (prior art)
101 Wheel head (prior art)
102 Axle shaft (prior art)
103 Tubular section (prior art)
104 Axle bridge (prior art)
105 End-flange (prior art)
106 Bearing (prior art)
107 Oil sump (prior art)
108 Hollow space (prior art)
1, 1a, 1b Axle bridge system
2 Wheel head
3 Axle shaft
4 Axle bridge
5 Tubular section
6 Bearing
7 First oil sump
8 End-flange
9 Hollow space
10 Second oil sump
11, 11a Radial shaft sealing ring
12, 12a Sealing lip
13 Sleeve
14 Sealing ring seat
15 Contact element
16 First, lower portion of the contact element
17 Second, upper portion of the contact element
18 Projection
19, 19a Arms
20, 20a Tension springs
21a, 21b Longitudinal bores
22a, 22b Transverse bores
23a, 23b, 23c Closure plugs
24 Air space
25 Main aggregate
26 Aggregate vent
AX Axial direction

1. An Axle bridge system (1, 1a, 1b) for a vehicle axle, the axle bridge system (1, 1a, 1b) comprising:
an axle shaft (3) and an axle bridge (4) with a tubular section (5), whereby an inside space is formed, wherein the axle shaft (3) is mounted rotatably and extends in an axial direction (AX), wherein the inside space can be filled at least partially with lubricating fluid to form a first lubricating fluid space and a first lubricating fluid reservoir;
a wheel head (2) with a bearing (6), wherein the bearing (6) is arranged in the wheel head (2) and supports the axle shaft (3) rotatably, wherein the axle shaft (3) has at its end an end-flange (8) which is arranged in contact with the wheel head (2) and which forms with the wheel bead (2) a hollow space (9) so that there is a connection between the bearing (6) and the inside space,
and wherein the wheel head (2) defines a second lubricating fluid space for forming a second lubricating reservoir, wherein the second lubricating space is fluidically connected to the bearing (6) in order to lubricate the bearing (6) with lubricating fluid; and
a sealing ring arranged between the axle bridge (4) and the axle shaft (3), the sealing ring configured and arranged to block the connection between the bearing (6) and the inside space so that the first lubricating fluid reservoir is sealed relative to the second lubricating reservoir.

2. The axle bridge system (1, 1a, 1b) according to claim 1, wherein the sealing ring is arranged directly or indirectly between the axle bridge (4) and the axle shaft (3) and seals the first lubricating fluid space relative to the second lubricating fluid space.

3. The axle bridge system (1, 1a, 1b) according to claim 2, wherein the sealing ring also extends radially between the axle bridge (4) and the axle shaft (3).

4. The axle bridge system (1, 1a, 1b) according to claim 1, wherein the sealing ring has two sealing lips (12, 12a) arranged a distance apart in the axial direction (AX) and parallel to one another.

5. The axle bridge system (1, 1a, 1b) according to claim 4, wherein the sealing ring is arranged between the axle bridge (4), and the axle shaft (3) and the two sealing lips (12, 12a) are firmly in contact with the axle bridge (4) or the axle shaft (3).

6. The axle bridge system (1, 1a, 1b) according to claim 1, wherein the sealing ring has at least one sealing lip (12, 12a), and the axle bridge (4) has a sleeve (13) and the sealing lip (12, 12a) is in contact with the axle bridge (4) in the area of the sleeve (13).

7. The axle bridge system (1, 1a, 1b) according to claim 1, wherein the end-flange (8) comprises a scaling ring seat (14) facing toward the axle bridge (4) and projecting in the axial direction (AX), and wherein the sealing ring is arranged between the axle bridge (4) and the sealing ring seat (14).

8. The axle bridge system (1, 1a, 1b) according to claim 7, wherein the axially (AX) projecting sealing ring seat (14) is made integrally with the axle shaft (3).

9. The axle bridge system (1, 1a, 1b) according to claim 1, further comprising a contact element (15) having a first portion (16) is arranged between the axle bridge (4) and the axle shaft (3), the contact element having a second portion (17) projecting into the hollow space (9) formed by the end-flange (8) and the wheel head (2), and wherein the sealing ring is arranged between the second portion (17) of the contact element (15) and the axle shaft (3).

10. The axle bridge system (1, 1a, 1b) according to claim 9, wherein the contact element (15) is S-shaped.

11. The axle bridge system (1, 1a, 1b) according to claim 9, wherein the first portion (16) of the contact element (15) is arranged between the axle bridge (4) and the axle shaft (3).

12. The axle bridge system (1, 1a, 1b) according to claim 9, wherein the sealing ring has respective oppositely directed sealing lips (12, 12a).

13. The axle bridge system (1, 1a, 1b) according to claim 9, wherein venting ducts for venting are formed in the wheel head (2) and the axle bridge (4), wherein the venting ducts are connected to the second lubricating fluid space and wherein the venting ducts enable venting to the outside space.

14. The axle bridge system (1, 1a, 1b) according to claim 1, wherein venting ducts for venting are formed in the wheel head (2) and the axle bridge (4), wherein the venting ducts are connected to the second lubricating fluid space in order to vent that space via an adjacent main aggregate (25).
